(19) United States
(12) Patent Application Publication
(10) Pub. No.: US 2026/0240134 A1
(43) Pub. Date: Aug. 20, 2026

(54) Ice Fishing Tip Down System

(71) Applicant: Kurt Robert Baneck, Okauchee, WI (US)

(72) Inventor: Kurt Robert Baneck, Okauchee, WI (US)

(21) Appl. No.: 19/452,858

(22) Filed: Jan. 19, 2026

Related U.S. Application Data
(60) Provisional application No. 63/761,077, filed on Feb. 20, 2025.

(51) Int. Cl. A01K 97/01; A01K 87/08; A01K 97/10

(52) U.S. Cl. CPC A01K 97/01; A01K 87/08; A01K 97/10

(57) ABSTRACT

An ice fishing tip-down system includes a tripod support assembly and a rod holder that supports a fishing rod in a balanced ready position. A tilt/orientation sensor and a light source are integrated within or on a handle of the fishing rod such that, when the rod pivots downward in response to a fish strike, the tilt/orientation sensor activates the light source to provide a visible bite indication. In some implementations, the system includes an adjustable trip-point feature, such as a threaded adjustment member, to increase or decrease a force required to tip the fishing rod. In some implementations, the handle or an associated optical feature diffuses the light for multi-angle visibility, and the system may include a leg-spreader or bracing configured to lock a deployed leg spacing to improve stability.

### CROSS-REFERENCE TO RELATED APPLICATIONS

This application claims the benefit of U.S. Provisional Patent Application No. 63/761,077, filed Feb. 20, 2025 (the “Provisional Application”), the entire disclosure of which is incorporated herein by reference to the extent not inconsistent with this disclosure.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIAL SUBMITTED ON A COMPACT DISC OR AS A TEXT FILE

Not applicable.

### BACKGROUND OF THE INVENTION

### Field of the Invention

The present invention relates generally to ice fishing equipment and, more particularly, to tip-down fishing devices having enhanced bite detection visibility and improved stability in wind and adverse weather.

### Description of Related Art

Ice fishing often involves low-light conditions, including dawn, dusk, nighttime, fog, and snowfall. Anglers commonly employ tip-down devices to passively detect fish strikes across multiple lines while remaining compliant with local regulations.

Conventional tip-down devices can be difficult to see at night and in low-visibility weather. Conventional supports may also lack stability in windy conditions and on uneven ice, leading to tipping, misalignment, missed strikes, and false triggers.

Add-on illumination and bite notification accessories exist in the marketplace, but such accessories are commonly purchased separately, can increase overall cost, and may be lost or damaged during transport and use in harsh ice-fishing environments.

Accordingly, there is a need for an integrated tip-down system that improves visibility of bite detection at long distances, increases stability, and supports practical adjustment for different bait and fish conditions.

### BRIEF SUMMARY OF THE INVENTION

In general, the invention provides an ice fishing tip-down system including a tripod support, a rod holder that supports a fishing rod in a balanced ready position, and an integrated bite-indication assembly that provides a visible bite indication when the rod tips downward due to a fish strike.

In some implementations, the fishing rod includes a handle containing a power source, a tilt/orientation sensor, and a light source. The tilt/orientation sensor may close an electrical circuit (or otherwise provide a control signal) upon rod tipping, thereby activating the light source.

The tilt/orientation sensor may include, without limitation, a tilt ball switch, mercury switch, microelectromechanical systems (MEMS) sensor, accelerometer, inclinometer, gyroscope, or other tilt/angle/orientation sensor, including combinations thereof.

The visible bite indication may be steady illumination, flashing, pulsed, intensity-modulated, color-changing, or otherwise visually distinguishable.

In some implementations, the tripod includes a leg-spreader and/or cross-support members configured to set, maintain, and in some cases lock a stable leg spacing and low center of gravity for repeatable deployment and improved wind resistance.

In some implementations, the rod holder includes one or more grooves configured to receive one or more balance features of the fishing rod to support the fishing rod in the balanced ready position while permitting pivoting toward a tipped position in response to a fish strike.

In some implementations, the system includes an adjustable trip-point feature configured to adjust a tipping threshold of the fishing rod. The adjustable trip-point feature may include a threaded adjustment member on the rod holder that is selectively advanced or retracted to increase or decrease a force required to tip the fishing rod.

In some implementations, the handle and/or an optical feature associated with the handle is configured to diffuse light emitted by the light source. The optical feature may include, without limitation, a transparent, translucent, or semi-translucent polymeric handle portion, a frosted or textured surface, a diffuser lens, a light-pipe, an internal diffuser insert, or combinations thereof.

### BRIEF DESCRIPTION OF THE SEVERAL VIEWS OF THE DRAWING

FIG. 1 illustrates a perspective view of an ice fishing tip-down system positioned relative to an ice hole, including a tripod support structure, rod holder, and fishing rod including (a) rod blank, (b) rod handle, (c) rod holder, (d) tripod legs, (e) tripod supports, (f) ice hole.

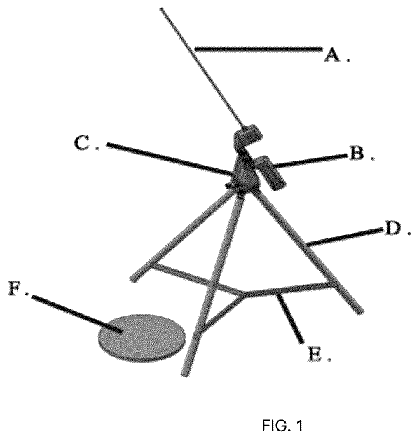

FIG. 2 illustrates an example rod holder including (a) one or more balance grooves configured to support the fishing rod and (b) a rest surface for a ready position and a threaded opening configured to receive a threaded adjustment member for adjusting a force required to tip the rod during a bite.

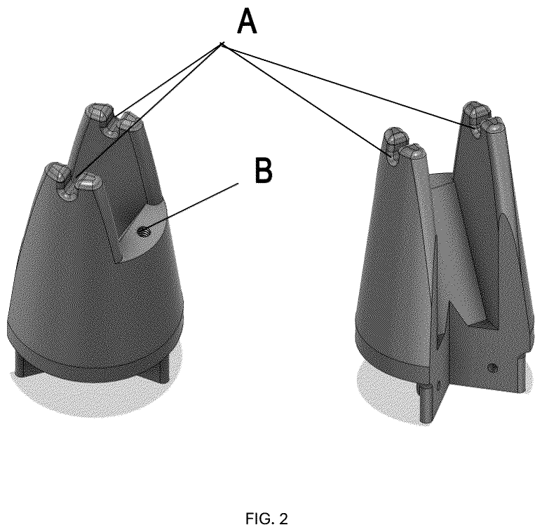

FIG. 3 illustrates an example rod handle including (a) a receptacle for a rod blank, (b) a hand grip configured for fish retrieval and optionally formed of a transparent, translucent, or semi-translucent material to diffuse an LED strike indication, (c) an opening for a balance feature (e.g., a balance pin), (d) a groove or channel for securing an accessory (e.g., a straight-line reel) using a strap or tie, and (e) an indicator module housing/compartment and cover for enclosing one or more of a light source, tilt/orientation sensor, battery, and on/off switch.

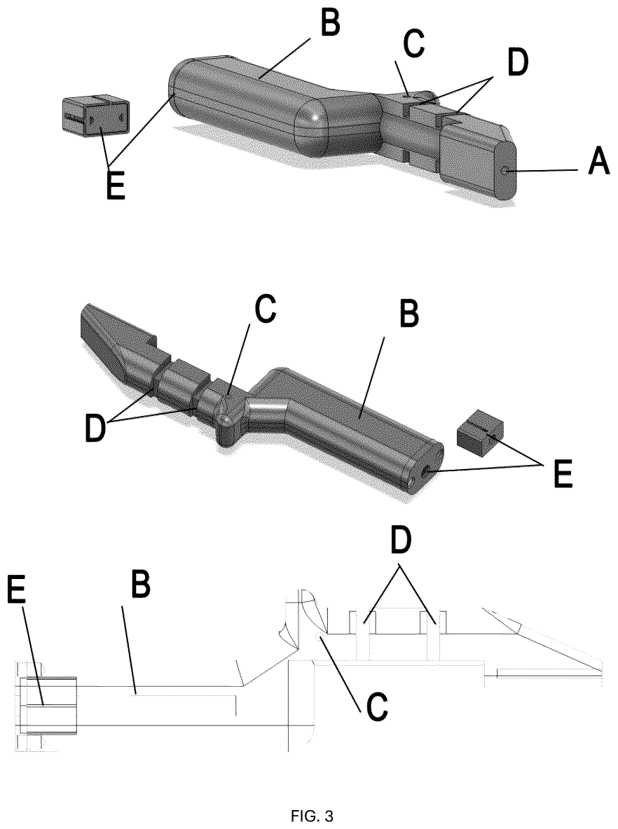

### DETAILED DESCRIPTION OF THE INVENTION

### Overview

The following description is provided to enable a person skilled in the art to make and use the invention. Various modifications will be apparent, and the invention may be practiced in different implementations. Accordingly, the invention is not limited to the examples described below.

A. Tripod Support Assembly. In some implementations, the system includes a tripod support assembly having a plurality of legs configured to rest on an ice surface adjacent an ice hole. The legs may be foldable, removable, or fixed, and may be formed from metal, polymer, composite, or other suitable materials.

In some implementations, the tripod includes one or more cross-support members coupled between legs to improve rigidity and stability in windy conditions.

In some implementations, the tripod includes a leg-spreader, brace, or support member configured to set and maintain a spacing between legs during deployment.

In some implementations, the tripod support/spreader mechanically locks the leg spacing to a repeatable deployed position to maintain a low center of gravity and consistent stability.

B. Rod Holder and Balance Interface. In some implementations, the tripod supports a rod holder positioned such that a fishing line extends through or near the ice hole.

In some implementations, the rod holder includes one or more grooves configured to receive and support one or more balance features of the fishing rod.

In some implementations, the fishing rod includes one or more balance pins configured to rest within the grooves of the rod holder.

In some implementations, the balance interface is configured such that light baits and light-bite conditions maintain the rod in the ready position, while a fish strike causes the rod to pivot downward toward the tipped position.

In some implementations, an adjustable trip-point feature is provided to adjust a tipping threshold of the fishing rod. The adjustable trip-point feature may be integrated into the rod holder and may be configured to change an effective resistance, interference, contact force, or moment arm associated with the fishing rod while in the ready position.

In some implementations, the adjustable trip-point feature comprises a threaded adjustment member (e.g., a bolt, screw, or set screw) coupled to the rod holder and positioned to contact the fishing rod or a component coupled to the fishing rod when the fishing rod is supported in the ready position.

In some implementations, advancing the threaded adjustment member farther into the rod holder increases the force required to tip the fishing rod from the ready position toward the tipped position, and retracting the threaded adjustment member decreases the force required to tip the fishing rod.

In some implementations, the threaded adjustment member includes a tool interface (e.g., slotted head, hex head, thumb screw, knurled knob) to permit adjustment in cold-weather use, including while wearing gloves.

C. Bite-Indication Electronics Module and Handle Features. In some implementations, the fishing rod includes a handle housing an indicator module comprising a power source, a light source configured to emit a visible bite indication, and a tilt/orientation sensor electrically coupled to the power source and the light source. The handle may further include a receptacle or opening configured to receive a rod blank, a grip portion configured for holding the rod during fish retrieval, one or more openings for coupling a balance feature (e.g., a balance pin), and one or more grooves or channels for securing an accessory (e.g., a straight-line reel) using a strap, tie, or fastener.

The tilt/orientation sensor may include, without limitation, a tilt ball switch, mercury switch, MEMS sensor, accelerometer, inclinometer, gyroscope, or combinations thereof.

In some implementations, when the rod pivots from the ready position toward the tipped position, the tilt/orientation sensor closes an electrical circuit or provides a control signal to activate the light source to provide the visible bite indication.

In some implementations, when the rod is returned manually from the tipped position to the ready position, the tilt/orientation sensor opens the circuit or removes the control signal to deactivate the light source.

In some implementations, the indicator module further includes a manual on/off switch configured to disable the light source independent of rod position.

In some implementations, the light source comprises one or more light-emitting diodes powered by one or more replaceable batteries and/or one or more rechargeable batteries, and the invention is not limited to any particular battery chemistry or form factor.

D. Light Diffusion/Visibility Features. In some implementations, the handle and/or an optical feature associated with the handle is configured to diffuse light emitted by the light source. The optical feature may include, without limitation, a transparent, translucent, or semi-translucent polymeric handle portion, a frosted or textured surface, a diffuser lens, a light-pipe, an internal diffuser insert, or combinations thereof.

In some implementations, the diffused optical output increases visibility of the bite indication from multiple angles and at long distances under low-light and adverse weather conditions.

E. Environmental Protection and Durability. In some implementations, the handle defines a compartment enclosing at least the tilt/orientation sensor and the power source.

In some implementations, a cover for the indicator module seals to the handle using a gasket, O-ring, adhesive, or interference fit to provide a water-resistant enclosure suitable for ice-fishing conditions.

In some implementations, the indicator module is configured to operate under cold temperatures and in wet environments typical of ice fishing.

What is claimed is:

1. An ice fishing tip-down system, comprising: (a) a support assembly comprising a tripod having a plurality of legs configured to rest on an ice surface adjacent an ice hole; (b) a rod holder carried by the support assembly; (c) a fishing rod configured to be supported by the rod holder in a ready position, the fishing rod comprising at least one balance feature configured to engage the rod holder such that the fishing rod is pivotable relative to the rod holder from the ready position toward a tipped position in response to a fish strike; and (d) an indicator module coupled to the fishing rod, the indicator module comprising: (i) a power source, (ii) a light source configured to emit a visible bite indication, and (iii) a tilt/orientation sensor electrically coupled to the power source and the light source, wherein the tilt/orientation sensor is configured to activate the light source when the fishing rod pivots from the ready position toward the tipped position.

2. The ice fishing tip-down system of claim 1, wherein the rod holder comprises at least one groove and the balance feature comprises at least one balance pin configured to rest within the groove to support the fishing rod in the ready position.

3. The ice fishing tip-down system of claim 1, further comprising an adjustable trip-point feature configured to adjust a force required to tip the fishing rod from the ready position toward the tipped position.

4. The ice fishing tip-down system of claim 3, wherein the adjustable trip-point feature comprises a threaded adjustment member coupled to the rod holder and selectively advanceable and retractable to increase or decrease the force required to tip the fishing rod.

5. The ice fishing tip-down system of claim 4, wherein the threaded adjustment member comprises a bolt, screw, or set screw.

6. The ice fishing tip-down system of claim 1, wherein the tripod further comprises a leg-spreader or brace configured to set and maintain a spacing between the legs, and wherein the leg-spreader or brace is configured to lock the spacing in a deployed position.

7. The ice fishing tip-down system of claim 1, wherein the support assembly further comprises at least one cross-support member connecting two or more of the legs to increase stability on the ice surface.

8. The ice fishing tip-down system of claim 1, wherein the tilt/orientation sensor comprises a tilt ball switch, a mercury switch, a MEMS sensor, an accelerometer, an inclinometer, a gyroscope, or combinations thereof.

9. The ice fishing tip-down system of claim 1, wherein the indicator module further comprises a manual on/off switch configured to disable the light source independent of rod position.

10. The ice fishing tip-down system of claim 1, wherein the tilt/orientation sensor is configured to deactivate the light source when the fishing rod is returned from the tipped position toward the ready position.

11. The ice fishing tip-down system of claim 1, wherein at least a portion of a handle of the fishing rod comprises, or is associated with, a light-diffusing optical feature configured to diffuse light emitted by the light source to improve visibility from multiple viewing angles.

12. The ice fishing tip-down system of claim 1, wherein the indicator module is housed within a handle of the fishing rod.

13. The ice fishing tip-down system of claim 12, wherein the handle comprises a compartment enclosing at least the tilt/orientation sensor and the power source, and wherein the compartment is sealed to resist moisture ingress.

14. The ice fishing tip-down system of claim 1, wherein the power source comprises one or more replaceable batteries or one or more rechargeable batteries.

15. A bite-indicating fishing rod assembly for ice fishing, comprising: (a) a fishing rod comprising a handle; (b) a light source within or on the handle, the light source configured to emit a visible bite indication; (c) a power source electrically coupled to the light source; and (d) a tilt/orientation sensor electrically coupled to the power source and the light source, wherein the tilt/orientation sensor is configured to activate the light source in response to a change in angular orientation of the fishing rod indicative of a fish strike.

16. The fishing rod assembly of claim 15, wherein the handle comprises, or is associated with, a light-diffusing optical feature configured to diffuse light emitted by the light source.

17. The fishing rod assembly of claim 15, further comprising a manual on/off switch on the handle configured to disable the light source.

18. The fishing rod assembly of claim 15, wherein the tilt/orientation sensor comprises a tilt ball switch, a mercury switch, a MEMS sensor, an accelerometer, an inclinometer, a gyroscope, or combinations thereof.

19. The fishing rod assembly of claim 15, wherein the tilt/orientation sensor is configured to deactivate the light source when the fishing rod is returned toward an upright or ready orientation.

20. The fishing rod assembly of claim 15, wherein the handle defines a sealed compartment enclosing at least the tilt/orientation sensor and the power source.
